(19) United States
(12) Patent Application Publication
(10) Pub. No.: US 2013/0083997 A1
(43) Pub. Date: Apr. 4, 2013

(54) TEMPORALLY STRUCTURED LIGHT

(71) Applicant: Kim MATTHEWS, WARREN, NJ (US)

(72) Inventor: Kim MATTHEWS, WARREN, NJ (US)

(73) Assignee: ALCATEL-LUCENT USA INC., MURRAY HILL, NJ (US)

(21) Appl. No.: 13/252,251

(22) Filed: Oct. 4, 2011

(51) Int. Cl. G06K 9/34

(52) U.S. Cl. 382/164; 382/173

(57) ABSTRACT

A method employing temporally structured light during scene production such that foreground/background separation/differentiation is enabled. According to an aspect of the present disclosure, the temporally structured light differentially illuminates various regions, elements, or objects within the scene such that these regions, elements or objects may be detected, differentiated, analyzed and/or transmitted as desired and/or required.

### TECHNICAL FIELD

This disclosure relates to methods, systems and devices employing temporally structured light for the production, distribution and differentiation of electronic representations of a scene.

### BACKGROUND

Technological developments that improve the ability to generate a scene or to differentiate between scene foreground and background as well as any objects or elements within the scene are of great interest due—in part—to the number of applications that employ scene generation/differentiation such as television broadcasting and teleconferencing.

### SUMMARY

An advance is made in the art according to an aspect of the present disclosure directed to the use of temporally structured light during scene production such that foreground/background separation/differentiation is enabled. According to an aspect of the present disclosure, the temporally structured light differentially illuminates various regions, elements, or objects within the scene such that these regions, elements or objects may be detected, differentiated, analyzed and/or transmitted.

In an exemplary instantiation, a temporal method of differentiating elements in a scene according to the present disclosure involves illuminating a first element of the scene with light having a particular temporal characteristic; illuminating a second element the scene with light having a different temporal characteristic; collecting images of the scene wherein the collected images include the first and second elements; and differentiating the first element from the second element included in the images from their temporal illuminations.

### BRIEF DESCRIPTION OF THE DRAWING

A more complete understanding of the present disclosure may be realized by reference to the accompanying drawings in which:

FIG. 1 is simplified block diagram showing representative scene components and arrangements according to an aspect of the present disclosure;

FIG. 2 is a flow diagram showing the steps associated with the method of the present disclosure; and

FIG. 3 is a simplified block diagram showing representative scene components of FIG. 1 including additional speakers that are differentiated according to an aspect of the present disclosure.

The illustrative embodiments are described more fully by the Figures and detailed description. The inventions may, however, be embodied in various forms and are not limited to embodiments described in the Figures and detailed description

### DESCRIPTION

The following merely illustrates the principles of this disclosure. It will thus be appreciated that those skilled in the art will be able to devise various arrangements—which although not all explicitly described or shown herein—embody the principles of the invention and are included within its spirit and scope.

Furthermore, all examples and conditional language recited herein are principally intended expressly to be only for pedagogical purposes to aid the reader in understanding the principles of the invention and the concepts contributed by the inventor(s) to furthering the art, and are to be construed as being without limitation to such specifically recited examples and conditions.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the diagrams herein represent conceptual views of illustrative structures embodying the principles of the disclosure. Accordingly, those skilled in the art will readily appreciate the applicability of the present disclosure to a variety of applications involving audio/video scenes such as teleconferencing, television broadcasting and digital motion pictures.

By way of some further background information, it is noted that video images—for example from video conferencing cameras of conference participant(s)—contain significantly more information than just the image(s) of the participant(s). Scene components and/or objects in the foreground and/or background of the participant(s) are but a few examples of scene elements that result in additional visual information. And while these additional elements and their resulting information may at times be useful they are oftentimes distracting, a potential privacy/security breach and consume significant amount(s) of bandwidth to transmit. Consequently, the ability to differentiate among such elements and segment the foreground/background of a scene from a participant or other elements of that scene is of considerable interest in the art.

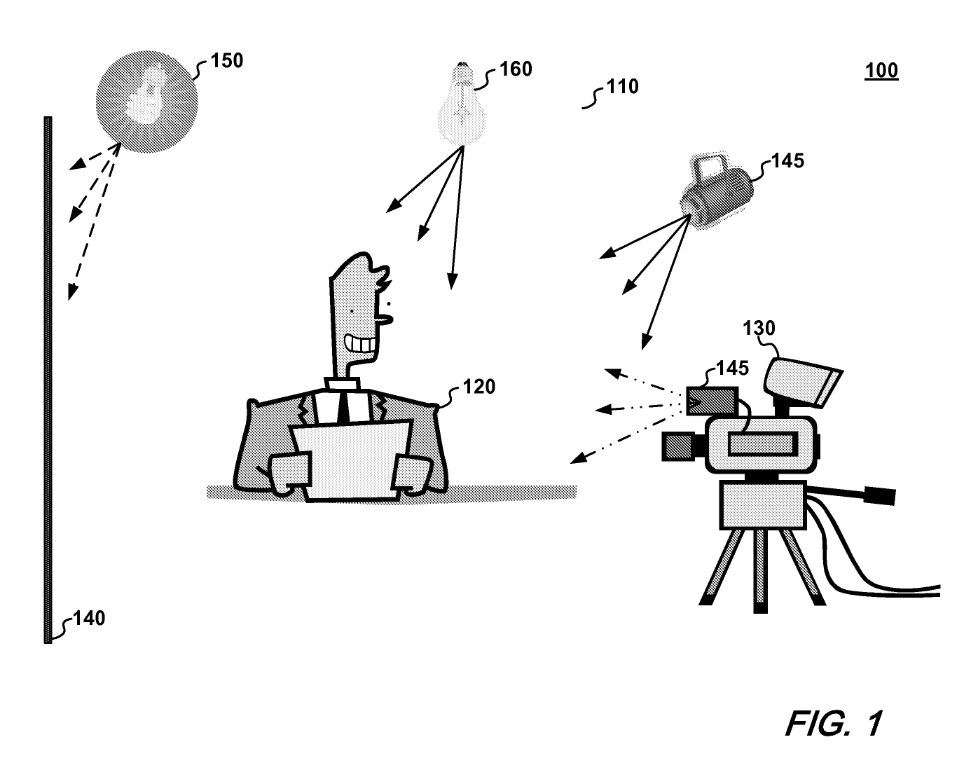

Turning now to FIG. 1 there is shown a schematic of an exemplary video conferencing/webcam arrangement 100 in which a participant 120 is situated within a videoconference room, studio, etc. 110. A video camera 130 generates electronic images of a scene within the room. A background 140 is shown in the figure such that the participant 120 is positioned between the video camera 130 and the background 140. Various light sources 150, 160, 170, 180—which will be discussed in greater detail—are positioned such that a desired level of lighting is realized.

As may be appreciated by those skilled in the art the arrangement/scenario depicted in FIG. 1 may be used, for example, for videotelephony, videoconferencing, webcams, television/movie production and broadcasting, etc., or any other application that involves the generation/capture of an image and its subsequent transmission and/or replay and/or storage.

Returning to our discussion of FIG. 1, it is noted further that in certain situations a background 140 such as that shown in FIG. 1 will change little over time. As a result when processing video or other images (frames) generated from a scene, it may be assumed that those aspects of the images (frames) that exhibit little change over time are in fact the background. Consequently, such “temporal frame differencing” may be used to differentiate the background from other scene elements. As may be further appreciated however, such techniques may fail when the background changes (due to—for example—changes in lighting, camera positioning or fleeting objects/elements). In addition, when a participant—in the case of a videoconference—does not exhibit sufficient movement that participant may be incorrectly determined to be a background component of the scene as well.

At this point it is noted that a video frame, a film frame or just a frame, is one of many single photographic or electronic images made of a scene.

Accordingly, the present disclosure employs temporally varying light sources—preferably at frequencies invisible to the human eye—to differentially illuminate (temporally) various regions of a scene such as that depicted in FIG. 1.

By way of specific initial example and as shown in FIG. 1, the background is illuminated with a fluorescent light 150 while the participant 120 is illuminated with an incandescent light 160.

Those skilled in the art will appreciate that the temporal characteristics of the incandescent light are quite different from the fluorescent light. More particularly, while an incandescent source will produce light exhibiting little or no flicker, such is not the case for the fluorescent. And while such flicker may be so slight as to be imperceptible to the human eye, it may advantageously be detected by a video or other image capture device. Accordingly—and as a result of temporal lighting differences—various elements of a scene may be differentiated.

Returning now to the discussion of FIG. 1, when the scene depicted in that FIG. 1 is so illuminated, even a consumer video camera having a relatively high-frame-rate (e.g., Sony PS-eye) may be used to detect time variations of the participant (or another object(s) illuminated by the incandescent light 160) and to differentiate that participant (or objects) from background or other objects illuminated with fluorescent light 150. Consequently, the background/objects/elements illuminated by the fluorescent light 150 may be differentiated/segmented from—for example—a participant that is illuminated by an incandescent lamp 160 or another lamp 170, 180 wherein the temporal output characteristics of the light(s) illuminating the participant are sufficiently different from temporal output characteristics of the light(s) illuminating the background (or other objects).

With these broad principles of temporally structured light and scene differentiation in place, it may be readily understood how systems and methods according to the present disclosure may be employed. For example, it is noted that in a videoconferencing environment many of the elements of a particular scene may change little (or not at all) from one frame to the next. More particularly, a participant/speaker may move or be animated while a background/walls or other objects do not move/change at all. Consequently, it may be desirable—to conserve bandwidth among other reasons—that only the scene elements comprising the participant/speaker needs to be transmitted to a remote conference location/participant while the background/walls do not need to be transmitted at all.

Accordingly, since the participant is illuminated with light having temporal characteristics that sufficiently differ from the temporal characteristics of light illuminating other objects/background elements, resulting images may be differentiated and transmitted independently thereby conserving telecommunications bandwidth. Advantageously, the light used may be “invisibly different” to the human eye and thereby differentiate different portions of a scene. Of further advantage, incandescent, fluorescent, LED and/or custom lighting may be specifically placed to enable this characteristic. When employed in this manner, cameras may be synchronized or not-synchronized to a particular lighting frequency and furthermore—programmable lighting—that is lighting with programmable characteristics such as frequency, duty cycle, phase for each color component (RGB) independently may be advantageously employed. Finally, when these techniques are employed, the ability to adjust (via program for example) the balance, intensity, color, hue and/or transparency properties of resulting images in real-time or from a recording. Individual frames (still images) may be advantageously processed in this manner as well.

As a further consideration and/or advantage, a videoconference environment/studio may include indicia that one does not wish to transmit. For example, the videoconference environment/studio may contain pictures/objects etc that one does not want to convey as it may divulge location and/or other sensitive information. According to an aspect of the present disclosure, those elements whose images one does not want to transmit may be illuminated by light sources exhibiting sufficiently different temporal characteristics from those elements whose images one does want to transmit. In this manner, images of those elements may be differentiated from other element images and only those images of elements that one desires to transmit may be transmitted (or stored).

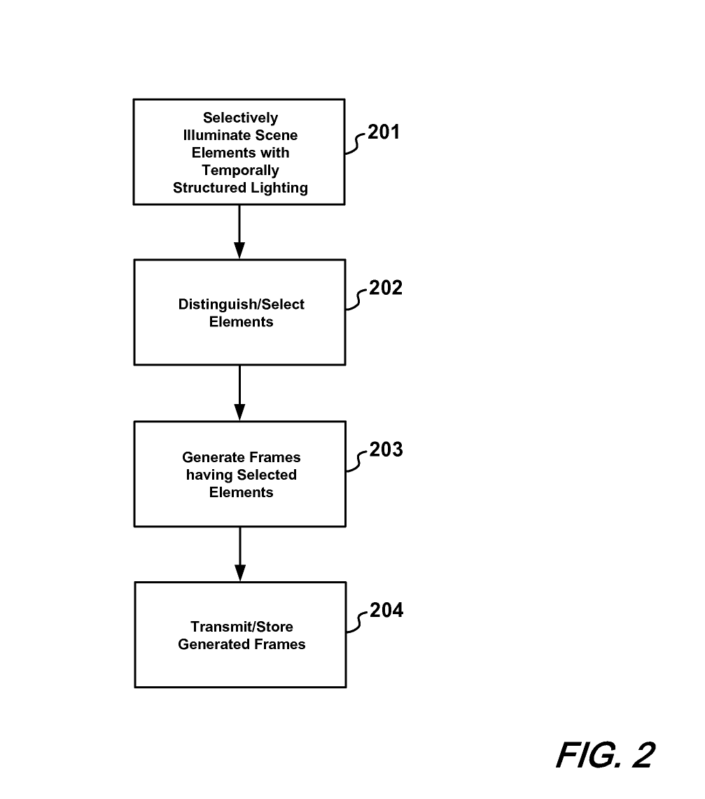

Turning now to FIG. 2, there is shown a flow diagram depicting the steps associated with a method according to an aspect of the present disclosure. More particularly, a scene—including a number of elements that are to be differentiated from one another is staged and/or produced. In a representative example, such a staged scene may include individual(s) participating in a videoconference from a videoconference room and any alternative suitable backgrounds/furnishings. As may be appreciated and for the purposes of this discussion, it is assumed that the individuals are active participants in the videoconference while the backgrounds/furnishings generally are not.

As is known, in a conventional videoconference, a videocamera produces electronic images of the scene including the participants and the backgrounds/furnishings and the images so produced are transmitted via telecommunications facilities to another (remote) videoconference location. Even though the background/furnishings are not active participants in the videoconference their images are nevertheless transmitted to the other videoconference location.

According to the present disclosure however, the active participants may be differentiated from other scene elements including the background by selectively illuminating those participants/elements with a number of light sources each having a desirable temporal characteristic (Block 201). For example and as noted previously, a speaker/active participant in a videoconference will be continuously illuminated by a particular light source—for example an incandescent source. Conversely, a background or other elements may be illuminated with light sources—for example fluorescent sources—exhibiting temporal characteristics different from those illuminating the speaker/active participant. As may be appreciated, since the temporal characteristics of the light sources are different, the elements illuminated by each may be distinguished from one another as images. (block 202)

Advantageously, the scene elements that are illuminated by light sources exhibiting different temporal characteristics may be differentiated by an image capture device (camera), or subsequently after capture by the camera. That is to say the image capture device may be synchronized with a particular light source such that elements illuminated by that source(s) are captured while others are not. Alternatively, the images may be post-processed after capture and elements (frames) selected or not as desired by appropriate image processing techniques.

Once the elements are so selected, frames including only those selected elements (frames) may be generated (block 203) and then subsequently transmitted and/or stored as desired (block 204).

At this point it is notable that while we have primarily described temporal light sources such as incandescent and/or fluorescent sources, other sources (i.e., LED) may be employed as well 178, 180. Advantageously, these other sources 170, 180 may be selectively driven such that a particular desired temporal characteristic of its output light is achieved and used for illumination of desired scene elements.

When these other light sources (i.e., LED) are employed, they may advantageously be modulated at higher cycle contrast (on/off), at varying frequencies or duty cycle times.

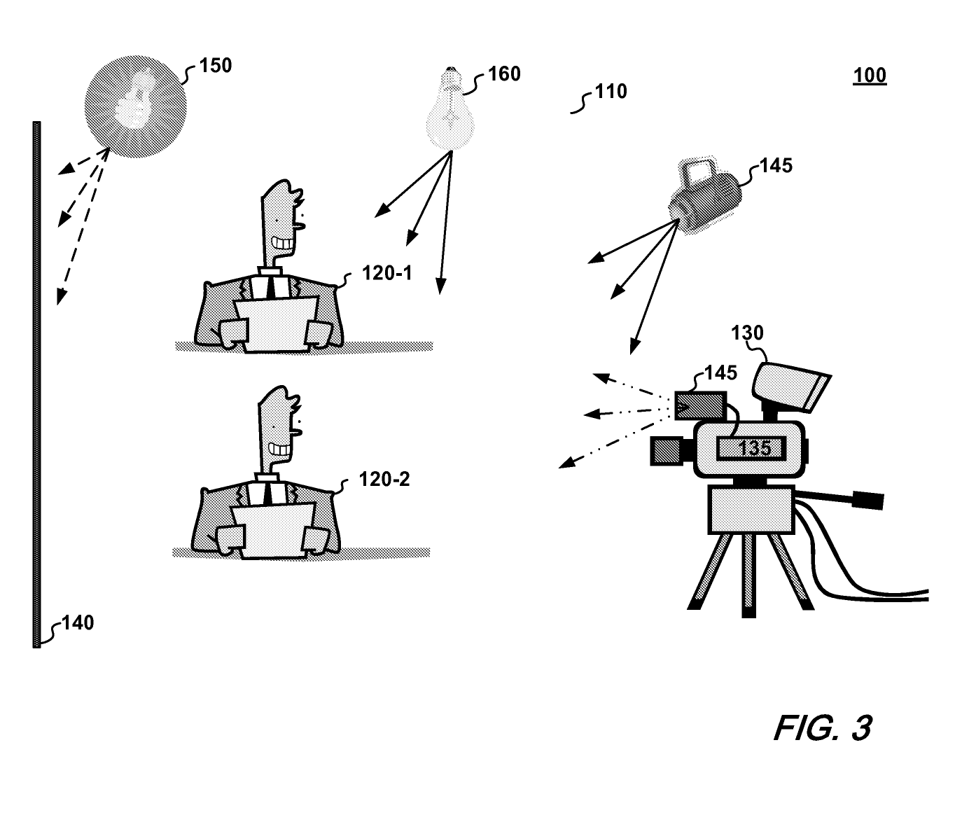

With reference to FIG. 3, there is shown the additional light sources 170, 180 within the studio videoconference arrangement shown previously. In addition to these additional light sources 170, 180 there are also two participants 120-1 and 120-2. If one or more of these additional light sources is selectively modulated and/or varied temporally, then it is possible to selectively distinguish the two participants 120-1, 120-2 from one another as well as from other background or other elements.

A further aspect of this arrangement shown in FIG. 3 is where one or more of the additional light sources i.e., 170 are constructed from multiple independent color sources (e.g., red, green blue) that may advantageously be modulated independently in frequency and/or phase. As a result the reliability of detection may be enhanced and the ability to differentiate the temporal differences of illuminated elements all without being detectable to the human eye.

In addition, it may be advantageous to employ light source modulation and camera shutter/image capture timing from a single source 135 (either optical or electronic) to further enhance the synchronization of image capture timing with the temporal characteristics of the light source thereby improving image quality and detection/discrimination reliability.

As may be now appreciated, one embodiment of the present disclosure may include a videoconference (or other) room arrangement in which lights illuminating walls of the room are temporally structured fluorescent while lights illuminating participants are incandescent. Cameras capturing entire scenes will capture and image both the walls and the participants.

Subsequent image processing of the captured images permit the differentiation of the participants (foreground) from the walls (background). As a result, image portions that correspond to the foreground may be subsequently compressed and transmitted while those portions corresponding to the background are not.

Furthermore, while we have discussed temporal light sources that produce light substantially in the visual portion of the spectrum, the disclosure of the present invention is not so limited. For example, with appropriate detection/collection devices, any wavelength(s) may be employed and different scene elements may be illuminated by these different wavelengths. In addition, it is noted that the sources and techniques described herein—while generally described with respect to moving images—may be applied to static images in both real-time and subsequently—in non real-time. Additionally, it is again noted that images captured may be recorded on any of a variety of known media, including magnetic, electronic, optical, opto-magnetic and or chemical.

At this point, while we have discussed and described the invention using some specific examples, those skilled in the art will recognize that our teachings are not so limited. Accordingly, the invention should be only limited by the scope of the claims attached hereto.

1. A temporal method of differentiating elements in a scene comprising:
illuminating a first element of the scene with light having a particular temporal characteristic;
illuminating a second element the scene with light having a different temporal characteristic;
collecting images of the scene wherein the collected images include the first and second elements; and
differentiating the first element from the second element included in the images from their temporal illuminations.

2. The temporal method according to claim 1 further comprising the steps of:
generating a differentiated image that includes an image of only desired elements.

3. The temporal method according to claim 2 further comprising the steps of:
compressing the differentiated image.

4. The temporal method according to claim 2 further comprising the steps of:
transmitting the differentiated image.

5. The temporal method according to claim 1 further comprising the steps of:
synchronizing the temporal characteristic of one of the lights with an image capture device.

6. The temporal method according to claim 1 wherein one of the lights is a fluorescent light.

7. The temporal method according to claim 1 wherein one of the lights is an incandescent light.

8. The temporal method according to claim 1 wherein one of the lights is an LED light.

9. The temporal method according to claim 1 wherein the temporal characteristics of the lights are imperceptible to a human eye.

10. The temporal method according to claim 1 wherein the lights are independently programmable with respect to frequency, duty cycle, and phase for one or more of its RGB color components.

11. The temporal method according to claim 1 further comprising the step of:
adjusting one or more properties of the images wherein said properties are selected from the group consisting of: intensity, color, hue, transparency, contrast, brightness, sharpness, distortion, size, and glare.

12. A recorded image comprising:
one or more scene elements wherein a number of the elements are illuminated with invisibly different lighting such that different portions of the scene may be differentiated.
